(19) United States
(12) Patent Application Publication
(10) Pub. No.: US 2025/0326659 A1
(43) Pub. Date: Oct. 23, 2025

(54) SENSING MODULE, WATER PURIFIER COMPRISING SAME, AND WATER PURIFIER ASSEMBLY

(71) Applicant: COWAY CO., LTD., Gongju-si (KR)

(72) Inventors: Hyun Kang LEE, Seoul (KR); Jong Hwan LEE, Seoul (KR); Hee Joo KANG, Seoul (KR); Hee Do JUNG, Seoul (KR); Chan Jung PARK, Seoul (KR)

(73) Assignee: COWAY CO., LTD., Gongju-si (KR)

(21) Appl. No.: 18/870,769

(22) PCT Filed: Jun. 1, 2023
(86) PCT No.: PCT/KR2023/007554

§ 371 Date: Dec. 2, 2024

(30) Foreign Application Priority Data
Jun. 3, 2022 (KR) 10-2022-0068555
Jun. 1, 2023 (KR) 10-2023-0070834

(51) Int. Cl. C02F 1/00

(52) U.S. Cl. CPC C02F 1/003; C02F 2201/007; C02F 2209/445; C02F 2307/10

(57) ABSTRACT

A sensing module includes: a support; a movable member supported on the support to be movable relative to the support; a magnetic supported on the movable member to be movable together with the movable member; and a reed switch supported on the support. The reed switch detects the magnetic when the movable member moves to one side and the magnetic is positioned within a preset distance from the reed switch.

### TECHNICAL FIELD

The present disclosure relates to a sensing module, a water purifier including the same, and a water purifier assembly.

### BACKGROUND ART

In general, a water purifier is a device that receives water from a water source such as a tap, filters the water into purified water through a filter provided therein, and then provides the purified water to a user. The water purifier uses a filter to filter water into purified water, and the water filtered by the filter flows through a flow path provided inside the water purifier to be dispensed from the water purifier.

Meanwhile, the filter installed in the water purifier needs to be replaced with a new filter because its filtration performance deteriorates after a certain period of use. The user removes the used filter from a main body and installs a new filter into the main body for use.

Korean Patent Application Publication No. 10-2013-0018528 entitled “Water purifier” (hereinafter, referred to as “Patent Document 1”) of the present applicant discloses a water purifier that allows a user to replace a purification filter by removing the purification filter from an installation housing.

However, the water purifier of Patent Document 1 is not provided with a separate sensor for detecting the purification filter, and it is difficult to determine whether the purification filter has been replaced from the installation housing. In other words, in the water purifier of Patent Document 1, even when the purification filter is replaced from the installation housing, it is difficult to determine whether the purification filter has been replaced unless the replacement process is visually confirmed.

Accordingly, a water purifier is being developed that uses a reed switch and a magnet used to determine whether a receiving member is seated or not in Patent Document 1 in determining whether a filter has been replaced. In such a water purifier, the reed switch provided in an installation housing detects the magnet provided in the filter, which makes it possible to determine whether the filter has been replaced.

However, in the case of the water purifier in which the reed switch provided in the installation housing detects the magnet provided in the filter to determine whether the filter has been replaced, the magnet is discarded together with the filter when the filter is replaced because the magnet is provided in the filter. In this case, the water purifier has a problem in that the filter and magnet are discarded together whenever the filter is replaced, and the magnet needs to be produced together with the filter every time, which results in excessive costs.

Therefore, there is a need for a water purifier that can detect whether the filter has been replaced while reducing production costs.

### DETAILED DESCRIPTION OF INVENTION

### Technical Problems

In view of the above, one embodiment of the present disclosure provides a sensing module capable of determining whether a filter has been replaced by detecting a magnetic moved by the filter when the filter is mounted in a filter frame, and a water purifier including the same.

In addition, one embodiment of the present disclosure provides a sensing module which configures a magnetic and a reed switch detecting the magnetic as a single module independent of a filter, thereby preventing the magnetic from being discarded when replacing the filter and reducing production costs, and a water purifier including the same.

Further, one embodiment of the present disclosure provides a sensing module capable of detecting the replacement of not only a filter mounted by moving vertically but also a filter mounted by moving horizontally depending on the orientation of a movable member supporting a magnetic, and a water purifier including the same.

### Technical Solution

In accordance with one aspect of the present disclosure, there is provided a sensing module including: a support; a movable member supported on the support to be movable relative to the support; a magnetic supported on the movable member to be movable together with the movable member; and a reed switch supported on the support, wherein the reed switch detects the magnetic when the movable member moves to one side and the magnetic is positioned within a preset distance from the reed switch.

Further, the sensing module may further include: an elastic member providing a restoring force to the movable member toward the other side opposite to the one side when the movable member moves to the one side, and the elastic member may have one end supported on the support and the other end supported on the movable member.

Further, the movable member may include an engagement part extending in a direction opposite to a direction in which the movable member moves, and the support may have a fixture formed therein that selectively interferes with the engagement part.

Further, the fixture may have a groove shape extending in the direction in which the movable member moves, and the engagement part may be positioned inside the fixture, and when the movable member moves a predetermined distance to the one side, the movable member may interfere with the fixture.

In accordance with another aspect of the present disclosure, there is provided a water purifier including: a frame including a filter frame in which a filter for filtering water is installed; and a sensing module for detecting whether the filter has been replaced from the filter frame, wherein the sensing module includes: a support supported on the frame; a movable member supported on the support to be movable relative to the support, the movable member moving in a direction away from the filter frame when the filter is installed in the filter frame; a magnetic supported on the movable member to be movable together with the movable member; and a reed switch supported on the support, and wherein the reed switch detects the magnetic when the movable member moves in the direction away from the filter frame and the magnetic is positioned within a preset distance from the reed switch.

Further, the water purifier may further include: an elastic member providing a restoring force to the movable member in a direction toward the filter frame when the movable member moves in the direction away from the filter frame, wherein the elastic member has one end supported on the support and the other end supported on the movable member.

Further, a through hole may be formed in the filter frame, and at least a portion of the movable member may pass through the through hole to be positioned inside the filter frame when the filter is removed from the filter frame.

Further, the movable member may include: a body part; and an engagement part extending from the body part in a direction different from the direction in which the movable member moves, and wherein the sensing module is supported on the frame to be placed in either a first posture in which at least a portion of the body part passes through the through hole to be positioned inside the filter frame or a second posture in which at least a portion of the engagement part passes through the through hole to be positioned inside the filter frame, when the filter is removed from the filter frame.

Further, the water purifier may further include: a control device which determines that the filter has been replaced from the filter frame when the magnetic is detected by the reed switch

In accordance with another aspect of the present disclosure, there is provided a water purifier assembly including: a filter for filtering water to provide purified water; and a water purifier in which the filter is detachably mounted, wherein the water purifier includes: a frame including a filter frame in which the filter is installed; and a sensing module for detecting whether the filter has been replaced from the filter frame, wherein the sensing module includes: a support supported on the frame; a movable member supported on the support to be movable relative to the support, the movable member moving in a direction away from the filter frame when the filter is mounted in the filter frame; a magnetic supported on the movable member to be movable together with the movable member; and a reed switch supported on the support, and wherein the reed switch detects the magnetic when the movable member moves in the direction away from the filter frame and the magnetic is positioned within a preset distance from the reed switch

### Effect of Invention

According to one embodiment of the present disclosure, when a filter is mounted in a filter frame or a flow path module is mounted in a main frame, it is possible to determine whether the filter or the flow path module has been replaced by detecting a magnetic moved by the filter or the flow path module.

Further, according to one embodiment of the present disclosure, by configuring the magnetic and the reed switch detecting the magnetic as a single module independent of the filter or the flow path module, it is possible to prevent the magnetic from being discarded when the filter or the flow path module is replaced and reduce production costs.

In addition, according to one embodiment of the present disclosure, it is possible to determine whether a filter or a flow path module, which is mounted in the water purifier by a movable member supporting a magnetic and moving vertically or horizontally depending on the orientation of the movable member, has been replaced.

### BRIEF DESCRIPTION OF THE DRAWINGS

FIG. 1 is a perspective view showing a water purifier assembly according to one embodiment of the present disclosure.

FIG. 2 is an exploded perspective view of the water purifier assembly of FIG. 1.

FIG. 3 is a cross sectional view taken along line III-III of FIG. 1.

FIG. 4 is a perspective view of a filter, a filter assembly, and a sensing module of FIG. 2.

FIG. 5 is a cross sectional view taken along line V-V of FIG. 4.

FIG. 6 is a perspective view when the filter of FIG. 4 is installed in the filter assembly.

FIG. 7 is a cross sectional view taken along line VII-VII of FIG. 6.

FIG. 8 is a perspective view of the sensing module of FIG. 4 when placed in a first posture.

FIG. 9 is a perspective view of the sensing module of FIG. 8 when switched to a second posture.

FIG. 10 is a perspective view of the sensing module of FIG. 9 when installed on the flow path module.

FIG. 11 is a cross sectional view taken along line XI-XI of FIG. 10.

FIG. 12 is a cross sectional view showing the movement of a movable member of the sensing module of FIG. 11.

### BEST MODE FOR CARRYING OUT THE INVENTION

Hereinafter, specific embodiments for implementing a spirit of the present disclosure will be described in detail with reference to the drawings.

In describing the present disclosure, detailed descriptions of known configurations or functions may be omitted to clarify the present disclosure.

Further, when an element is referred to as being ‘connected’ to, ‘supported’ by, or ‘mounted’ in, another element, it should be understood that the element may be directly connected to, supported by, or mounted in another element, but that other elements may exist in the middle.

The terms used in the present disclosure are only used for describing specific embodiments, and are not intended to limit the present disclosure. Singular expressions include plural expressions unless the context clearly indicates otherwise.

Further, terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Hereinafter, a water purifier assembly 1 according to one embodiment of the present disclosure will be described with reference to the drawings.

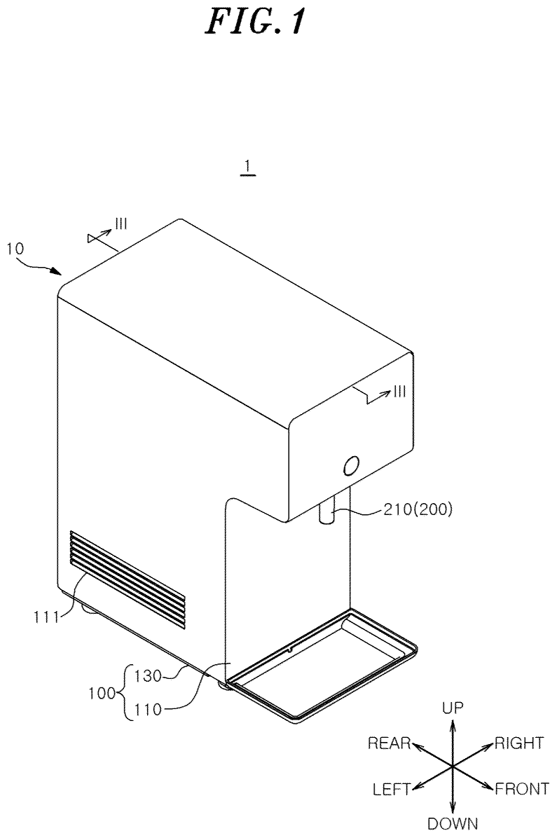

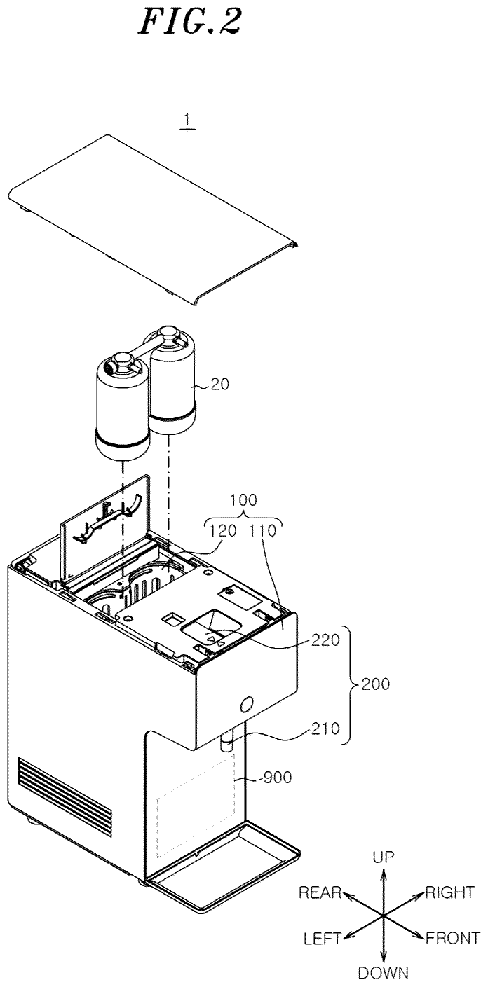

Referring to FIGS. 1 and 2, the water purifier assembly 1 according to one embodiment of the present disclosure can provide clean water to a user by filtering water supplied from an external source. For example, the water purifier assembly 1 may receive water from a water supply source (not shown) such as a tap, and filter the supplied water into clean water. The water purifier assembly 1 may include a water purifier 10 and a filter 20.

Referring to FIGS. 2 to 4, the water purifier 10 may filter water and provide clean water to a user when the filter 20 is installed therein. The water purifier 10 may include a frame 100, a flow path module 200, a cooling body 300, a cooling unit 400, a heat dissipation unit 500, a fan unit 600, a power supply device 700, a sensing module 800, and a control device 900.

The frame 100 may support the flow path module 200, the cooling body 300, the cooling unit 400, the heat dissipation unit 500, the fan unit 600, the power supply device 700, and the sensing module 800. In addition, the frame 100 may accommodate the cooling body 300, the cooling unit 400, the heat dissipation unit 500, the fan unit 600, the power supply device 700, and the sensing module 800 therein. The frame 100 may include a main frame 110 and a filter frame 120.

The main frame 110 may support the flow path module 200, the cooling body 300, the cooling unit 400, the heat dissipation unit 500, the fan unit 600, the power supply device 700, and the sensing module 800. In addition, the main frame 110 may support the filter frame 120. The main frame 110 may have an inlet 111 and an outlet 112.

The inlet 111 may be formed in the main frame 110 to allow air to flow into the frame 100. The inlet 111 may be provided in plurality, and the plurality of inlets 111 may be formed on left and right side surfaces of the main frame 110, respectively. In addition, the plurality of inlets 111 may be arranged adjacent to a lower portion of the main frame 110.

The outlet 112 may be formed in the main frame 110 to allow air introduced in the frame 100 to be discharged therethrough. The outlet 112 may be formed at a rear surface of the main frame 110 and may be provided in plurality.

The filter frame 120 may support the filter 20 and provide a space in which the filter is installed. The filter frame 120 may be supported on the main frame 110 to be placed above the cooling body 300 and on the front side of a heat sink 520 to be described later. In addition, a through hole 121 may be formed in the filter frame 120.

The through hole 121 may be formed in the filter frame 120 so that a movable member 820 of the sensing module 800 to be described later may pass therethrough. For example, at least a portion of the movable member 820 may be placed inside the filter frame 120 through the through hole 121, and when the movable member 820 is pressed by the filter 20, the movable member 820 may move inside the through hole 121. The through hole 121 may be provided to penetrate the filter frame 120 in a front and rear direction.

The flow path module 200 may guide water filtered in the filter 20 to an outside of the frame 100. The flow path module 200 may be supported on the main frame 110 to be placed in a front portion of the main frame 110. In addition, the flow path module 200 may be detachably mounted in the main frame 110 to allow replacement. The flow path module 200 may include a water outlet section 210 and a flow path section 220.

The water outlet section 210 may discharge water flowing along the flow path section 220 to the outside. The water outlet section 210 may be disposed in the front portion of the main frame 110, and at least a portion of the water outlet section 210 may be exposed to the outside of the frame 100. In addition, the water outlet section 210 may be in communication with the flow path section 220. Meanwhile, in the present specification, the water outlet section 210 has been described as a single structure with the flow path section 220, but this is merely an example. The water outlet section 210 may be provided as a separate structure from the flow path section 220, and may also be formed integrally with the frame 100.

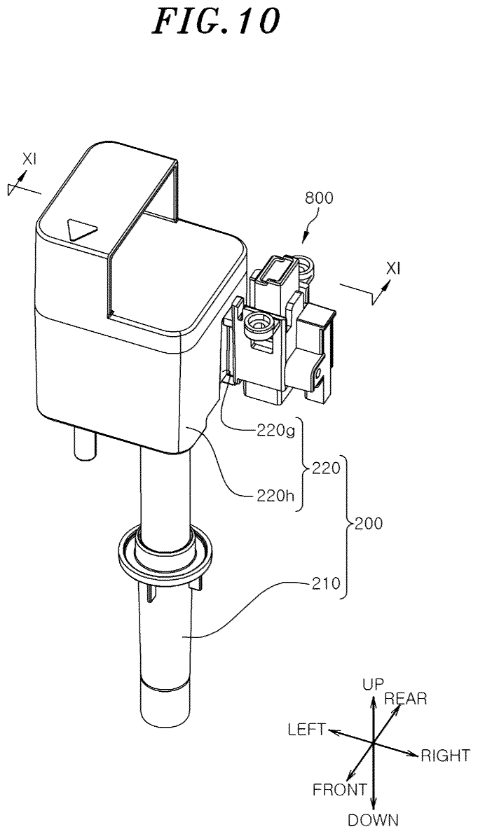

The flow path section 220 may provide a passage for water to flow. The flow path section 220 may guide water filtered by the filter 20 to the water outlet section 210. In addition, the flow path section 220 may be disposed in the front portion of the main frame 110 and may be disposed above the water outlet section 210. Further, referring to FIG. 10, the flow path section 220 may include a flow path housing 220h that accommodates and supports the passage for water to flow. The flow path housing 220h may include an engagement part receiving groove 220g that can accommodate a portion of an engagement part 200 of the sensing module 800 to be described later. The engagement part receiving groove 220g may be recessed inward from a surface of the flow path housing 220h while extending in an up and down direction, and may have an open lower end and a closed upper end.

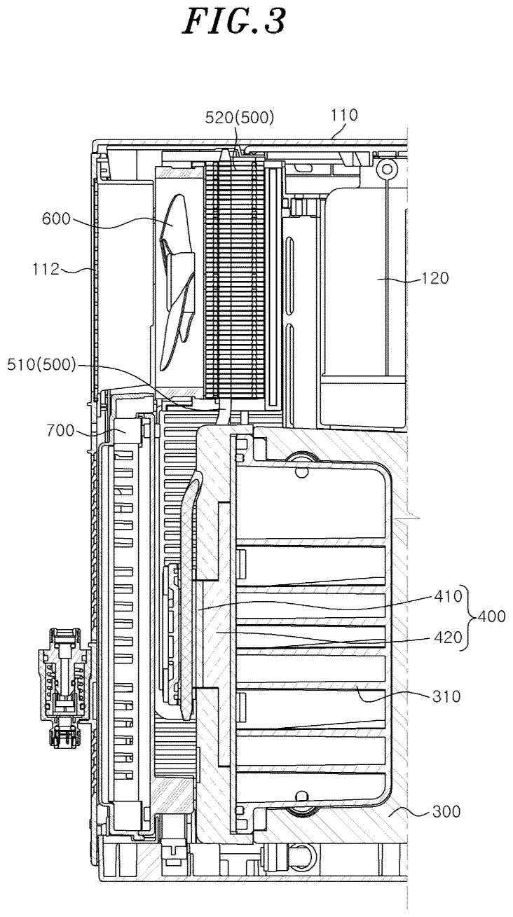

Referring again to FIG. 3, the cooling body 300 may provide a space in which the introduced water is cooled to a predetermined temperature or lower. In addition, the cooling body 300 may support the cooling unit 400, and one surface of the cooling unit 400 may be in contact with an outer surface of the cooling body 300. In this case, the cold generated in the cooling unit 400 may be transferred to the interior of the cooling body 300.

The cooling body 300 may provide a space for water to flow. For example, the cooling body 300 may be configured as a direct flow type to provide a passage for water to flow. In this case, the cooling body 300 is provided with a plurality of partitions 310 that are arranged in an offset manner, and the passage for water to flow may be formed by the plurality of partitions 310. In addition, water introduced from the top of the cooling body 300 may be discharged through the bottom of the cooling body 300. Meanwhile, the flow direction of water flowing along the passage formed inside the cooling body 300 may be changed a plurality of times by the plurality of partitions 310. Further, water introduced into the cooling body 300 may be cooled by the cooling unit 400 while flowing along the plurality of partitions 310.

However, the spirit of the present disclosure is not necessarily limited to the above, and as another example, the cooling body 300 may be a reservoir type water tank capable of containing water. In this case, the cooling body 300 may provide a space for containing the introduced water, and may provide a space for containing the cold water cooled by the cooling unit 400. For example, the water contained in the cooling body 300 may rise from the bottom to the top of the cooling body 300 as water flows into the cooling body 300. The water introduced in the cooling body 300 can be cooled by the cooling unit 400 as it fills up.

As another example, the cooling body 300 may have a pipe shape (not shown) that allows the first in water to be first discharged. In this case, water flowing along the pipe may be cooled by the cooling unit 400. In addition, water introduced into the pipe of the cooling body 300 can be cooled to a low temperature while flowing along the pipe and then discharged from the pipe.

The cooling unit 400 can cool water introduced into the cooling body 300 to the predetermined temperature or lower. The cooling unit 400 may be supported on the cooling body 300 such that one surface thereof contacts the outer surface of the cooling body 300. In addition, the cooling unit 400 may be supported on the rear side of the cooling body 300. For example, the cooling unit 400 may be supported on the cooling body 300 such that a front surface thereof contacts a rear surface of the cooling body 300. Further, the cooling unit 400 may receive power from the power supply device 700, and the power transmitted to the cooling unit 400 may be controlled by the power supply device 700.

In addition, the cooling unit 400 may be configured as an electronic cooling device, which may omit a cooling system such as an evaporator or compressor, thereby cooling water with minimal volume. The cooling unit 400 may include a thermoelectric module 410 and a cold block 420.

The thermoelectric module 410 may be cooled on one side and heated on the other side when current flows through it. A front surface of the thermoelectric module 410 may be in contact with a rear surface of the cold block 420. For example, when the front surface of the thermoelectric module 410 is cooled, cold generated in the thermoelectric module 410 is transferred to the rear surface of the cooling body 300 through the cold block 420. A rear surface of the thermoelectric module 410 may be in contact with a heat pipe 510 to be described later, and heat generated in the thermoelectric module 410 may be transferred to the heat pipe 510.

The cold block 420 can transfer the cold generated in the thermoelectric module 410 to the cooling body 300. The cold block 420 may be supported on the cooling body 300 such that a front surface thereof contacts the rear surface of the cooling body 300. In addition, the cold block 420 may support the thermoelectric module 410 such that the rear surface thereof contacts the front surface of the thermoelectric module 410. The cold generated in the thermoelectric module 410 can be transferred to water inside the cooling body 300 through the cold block 420. For example, the cold block 420 may be formed of a material with high thermal conductivity. In addition, the cold block 420 may be directly adhered to the cooling body 300 and may be coupled to the cooling body 300 by a fastening member such as a screw.

The heat dissipation unit 500 can release heat generated in the thermoelectric module 410 to the outside to prevent the cooling efficiency of the thermoelectric module 410 from decreasing. In addition, the heat dissipation unit 500 can release heat generated in the power supply device 700 to the outside. The heat dissipation unit 500 may include a heat pipe 510 and a heat sink 520.

The heat pipe 510 is disposed at the rear surface of the thermoelectric module 410 and can transfer heat generated in the thermoelectric module 410 to the heat sink 520. For example, the heat pipe 510 can receive heat from the thermoelectric module 410 through a heat conductor and transfer the received heat to the heat sink 520. The heat pipe 510 may be formed of a material having high thermal conductivity and may be provided in plurality.

The heat sink 520 can release heat transferred from the heat pipe 510 to the outside. The heat sink 520 may be disposed on the upper side of the cooling body 300 and may be spaced apart upward from the cooling body 300. The heat sink 520 is placed on the upper side of the heat pipe 510 and connected to the heat pipe 510, and can receive heat from the heat pipe 510.

The fan unit 600 can cause air to flow so that external air of the frame 100 is drawn into the interior of the frame 100 and air drawn into the interior of the frame 100 is discharged to the outside of the frame 100. For example, when the fan unit 600 is operated, external air can be drawn into the interior of the frame 100 through the inlet 111, and air drawn into the interior of the frame 100 can be discharged to the outside of the frame 100 through the outlet 112.

The power supply device 700 can supply power to the thermoelectric module 410 and the fan unit 600. The power supply device 700 may be electrically connected to the thermoelectric module 410 and the fan unit 600. For example, the power supply device 700 may be a switched mode power supply (SMPS). However, this is merely an example, and the power supply device 700 may be any known device that can supply power to the thermoelectric module 410 and the fan unit 600.

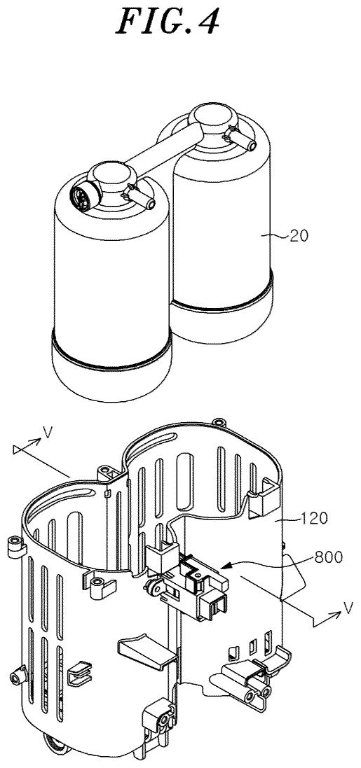

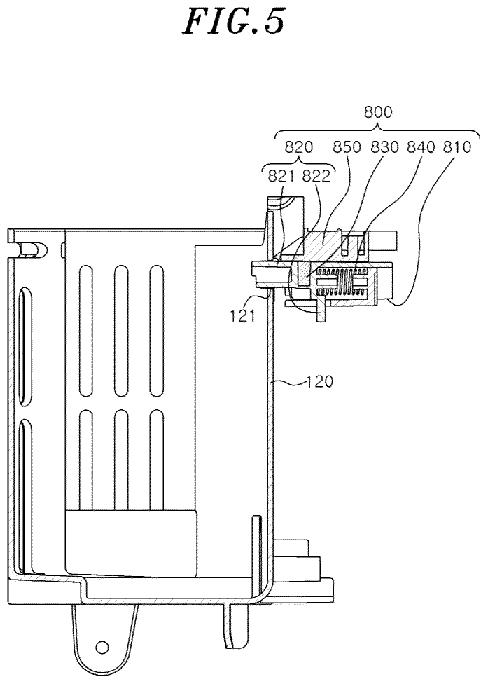

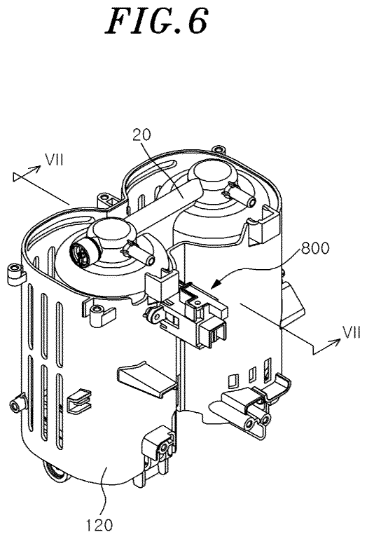

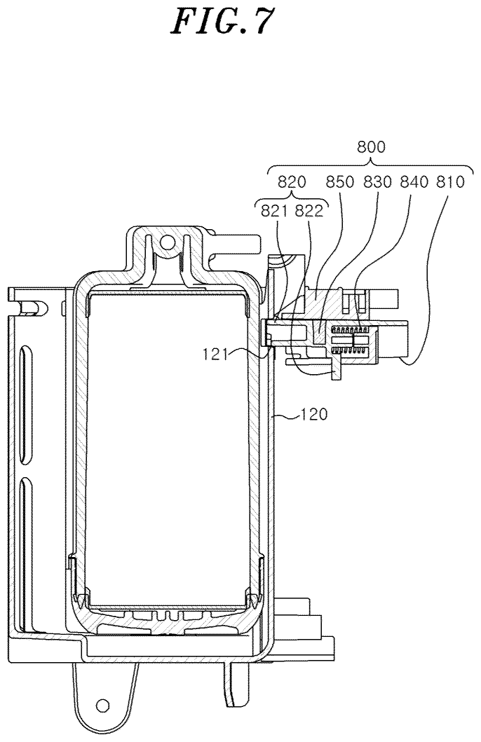

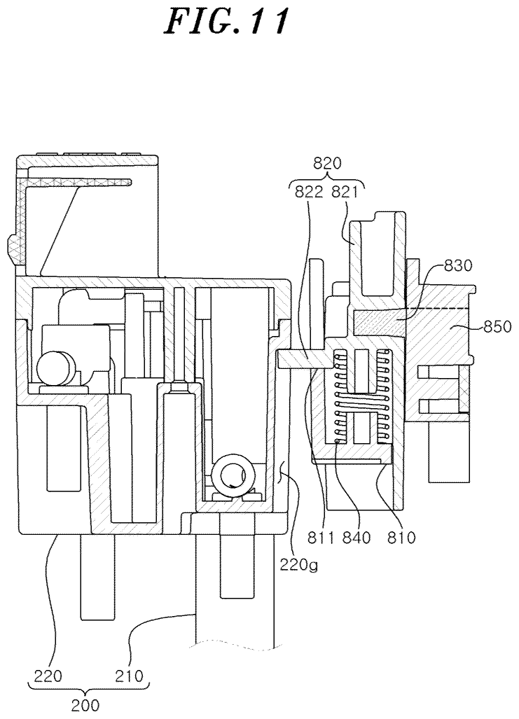

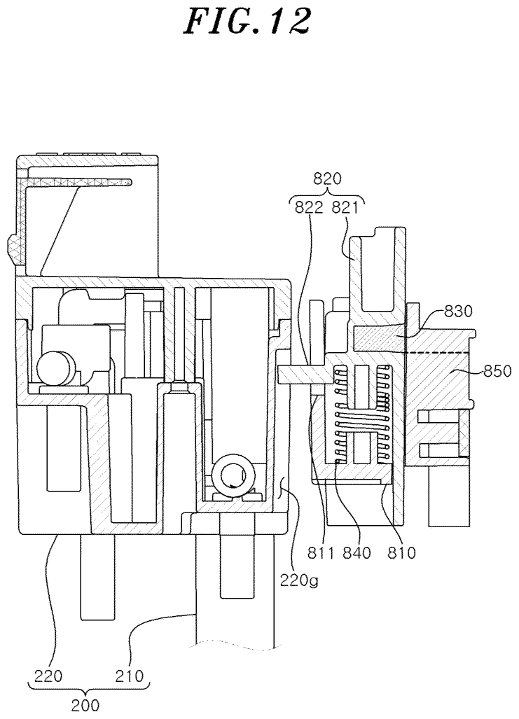

The sensing module 800 can detect whether the filter 20 has been replaced in the filter frame 120 or whether the flow path module 200 has been mounted to the main frame 110. In other words, the sensing module 800 can detect whether the filter 20 has been replaced by detecting whether the filter 20 has been installed in the filter frame 120, or can detect whether the flow path module 200 has been replaced by detecting whether the flow path module 200 is mounted to the main frame 110. For example, referring to FIGS. 4 and 5, the sensing module 800 can detect whether the filter 20 has been removed from the filter frame 120 when the filter 20 is removed from the filter frame 120. As another example, referring to FIGS. 6 and 7, the sensing module 800 can detect whether the filter 20 has been mounted to the filter frame 120 when the filter 20 is mounted to the filter frame 120. Further, referring to FIG. 11, the sensing module 800 can detect whether the flow path module 200 has been mounted to the main frame 110 when the flow path module 200 is mounted to the main frame 110. As another example, referring to FIG. 12, the sensing module 800 can detect whether the flow path module 200 has been removed from the main frame 110 when the flow path module 200 is removed from the main frame 110. The sensing module 800 may be supported on either the main frame 110 or the filter frame 120.

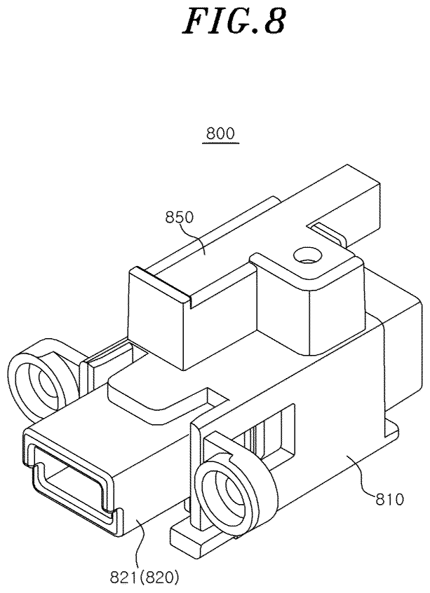

Meanwhile, referring to FIGS. 7 to 11, the sensing module 800 may include a support 810, a movable member 820, a magnetic 830, an elastic member 840, and a reed switch 850.

The support 810 may support the movable member 820, the elastic member 840, and the reed switch 850. For example, the support 810 may support the movable member 820 to be movable. The support 810 may have an internal space formed to accommodate the movable member 820, and the movable member 820 can move in the internal space of the support 810. In addition, the support 810 may be open on both sides in a direction in which the movable member 820 moves. A fixture 811 that can be engaged with the movable member 820 may be formed on the support 810.

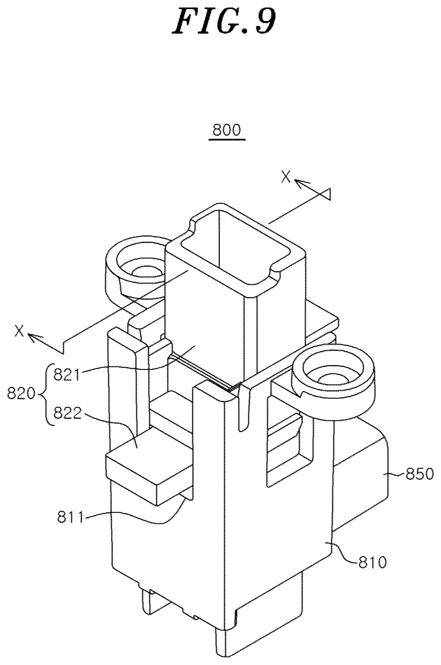

Referring to FIG. 9, the fixture 811 may be formed on a side surface of the support 810 and may selectively interfere with an engagement part 822 of the movable member 820, which will be described later. For example, the fixture 811 may have a groove shape extending along the direction in which the movable member 820 moves. In this case, the engagement part 822 may move while being inserted inside the fixture 811 and may selectively interfere with the fixture 811.

The movable member 820 may be supported on the support 810 to be movable relative to the support 810. For example, the movable member 820 may move in either the up and down direction or the horizontal direction depending on the orientation of the sensing module 800. In addition, the movable member 820 may support the magnetic 830 and may move relative to the support 810 together with the magnetic 830.

Referring again to FIG. 5, when the filter 20 is removed from the filter frame 120, at least a portion of the movable member 820 can pass through the through hole 121 to be positioned inside the filter frame 120. For example, when the filter 20 is removed from the filter frame 120, one end of the movable member 820 may be positioned inside the filter frame 120. In addition, referring again to FIG. 7, when the filter 20 is installed in the filter frame 120, one end of the movable member 820 may move in a direction away from the filter 20.

Meanwhile, the movable member 820 may include a body part 821 and an engagement part 822.

The body part 821 may be supported on the support 810 to be movable relative to the support 810. The body part 821 may be disposed inside the support 810 and may move within the support 810. In addition, at least a portion of the body part 821 may pass through the through hole 121 to be positioned inside the filter frame 120. The body part 821 may support the engagement part 822.

Referring to FIGS. 9, 11, and 12, the engagement part 822 may selectively interfere with the fixture 811. For example, when the engagement part 822 moves a predetermined distance to one side, it interferes with the fixture 811. The engagement part 822 may extend from the body part 821 in a direction that is different from the direction in which the movable member 820 moves. In addition, the engagement part 822 is placed inside the fixture 811 and can move within the fixture 811. The engagement part 822 interferes with the fixture 811 when the body part 821 moves in a direction away from the filter frame 120. In this case, the body part 821 can be prevented from moving away from the filter frame 120 excessively. In addition, the engagement part 822 may protrude from the body part 821 to be engaged with a groove or step of a housing of a component that needs to be replaced among the components in the water purifier.

The magnetic 830 may be supported on the movable member 820 to be movable together with the movable member 820. For example, the magnetic 830 may be supported inside the movable member 820 and may move in response to the movement of the movable member 820. The magnetic 830 may be provided as a known means having magnetism.

When the movable member 820 moves to one side, the elastic member 840 may provide a restoring force to the movable member 820 toward the other side opposite to one side. For example, when the sensing module 800 is mounted in the filter frame 120, the elastic member 840 may provide a restoring force to the movable member 820 toward the filter frame 120 when the movable member 820 moves away from the filter frame 120. By the elastic member 840, when the filter 20 is removed from the filter frame 120, at least a portion of the movable member 820 may remain positioned inside the filter frame 120. In addition, for example, when the sensing module 800 is connected to the main frame 110 adjacent to the flow path module 200, the elastic member 840 may provide a restoring force to the movable member 820 so that the movable member 820 moves to the original position when the movable member 820 is moved by the flow path module 200. Further, the elastic member 840 may have one end supported on the support 810 and the other end supported on the movable member 820. The reed switch 850 may detect the magnetism of the magnetic 830 when the magnetic 830 is placed within a preset distance. For example, when the filter 20 is installed in the filter frame 120 and the movable member 820 moves away from the filter 20, the reed switch 850 may detect the magnetism of the magnetic 830 moved by the movable member 820. In addition, when the filter 20 is removed from the filter frame 120 and the movable member 820 moves toward the inside of the filter frame 120, the reed switch 850 may not detect the magnetism of the magnetic 830 moved by the movable member 820. Further, for example, in a state where the sensing module 800 is attached to the main frame 110 adjacent to the flow path module 200, when during the process of mounting the flow path module 200 in the main frame 110, the movable member 820 is moved together with the magnetic 830 and the reed switch 850 and the magnetic 830 are positioned within a preset distance, the reed switch 850 can detect the magnetism of the magnetic 830. In addition, when the flow path module 200 is removed from the main frame 110, the movable member 820 moves away from the reed switch 850, and the reed switch 850 and the magnetic 830 are positioned beyond the preset distance, the reed switch 850 may not detect the magnetism of the magnetic 830 moved by the movable member 820.

The reed switch 850 may generate an electrical signal to the control device 900 based on whether the magnetism of the magnetic 830 is detected. For example, the reed switch 850 may generate an electrical signal when it detects the magnetism of the magnetic 830, and transmit the generated electrical signal to the control device 900. In addition, the reed switch 850 may be supported on the support 810.

Meanwhile, the sensing module 800 may be supported on the frame 100 to be placed in one of a first posture and a second posture. Referring to FIGS. 5 to 8, in the present specification, the first posture of the sensing module 800 may be a posture in which the sensing module 800 is supported on the frame 100 such that the movable member 820 moves in the horizontal direction. The first posture may be a posture in which, when the filter 20 is removed from the filter frame 120, at least a portion of the body part 821 of the sensing module 800 passes through the through hole 121 of the filter frame 120 to be positioned inside the filter frame 120. In this case, the sensing module 800 may move in the horizontal direction and detect whether the filter 20 installed in the filter frame 120 has been replaced. In addition, referring to FIG. 9, the second posture of the sensing module 800 may be a posture in which the sensing module 800 is supported on the frame 100 such that the movable member 820 moves in the up and down direction.

Referring to FIG. 11, when the flow path module 200 is mounted in the main frame 110, as the flow path module 200 moves down while a portion of the engagement part 822 is received in the engagement part receiving groove 200g, an upper end of the engagement part 822 comes into contact with the upper end of the engagement part receiving groove 200g and moves downward. Then, the reed switch 850 and the magnetic 830 are positioned within the preset distance, and the reed switch 850 detects the magnetism of the magnetic 830, and based on this, the control device 900 may determine that the flow path module 200 has been mounted on the main frame 110.

Referring to FIG. 12, when the flow path module 200 is removed from the main frame 110, as the flow path module 200 moves up while a portion of the engagement part 822 is received in the engagement part receiving groove 200g, the upper end of the engagement part 822 is separated from the upper end of the engagement part receiving groove 200g and moves upward. Then, the reed switch 850 and the magnetic 830 are positioned beyond the preset distance, and the reed switch 850 may no longer detect the magnetism of the magnetic 830. Based on this, the control device 900 may determine that the flow path module 200 has been removed from the main frame 110. In addition, a plurality of sensing modules 800 may be provided. Some of the plurality of sensing modules 800 may detect whether the filter 20 installed in the filter frame 120 has been replaced, and other of the sensing modules 800 may detect whether the flow path module 200 mounted in the frame 100 has been replaced. For example, the sensing module 800 may be positioned adjacent to the flow path module 200 on the front side of the frame 100 and may detect whether the flow path module 200 has been replaced. In this case, the sensing module 800 is supported on the frame 100 to be in the second posture, and may detect whether the flow path module 200 moving in the up and down direction to be removed from or mounted in the frame 100 has been replaced.

The control device 900 may determine that the filter 20 has been replaced from the filter frame 120 when the magnetism of the magnetic 830 is detected by the reed switch 850. For example, when the filter 20 is mounted in the filter frame 120, the reed switch 850 may generate an electrical signal by detecting the magnetism of the magnetic 830 when the magnetic 830 is positioned within the preset distance. In this case, the control device 900 may determine that the filter 20 has been replaced from the filter frame 120 by receiving the electrical signal from the reed switch 850. In addition, when the flow path module 200 is mounted in the main frame 110, the reed switch 850 may generate an electrical signal by detecting the magnetism of the magnetic 830 when the magnetic 830 is positioned within the preset distance. In this case, the control device 900 may determine that the flow path module 200 has been replaced from the main frame 110 by receiving the electrical signal from the reed switch 850. The control device 900 may be implemented by a computing device including a microprocessor, a measuring device such as a sensor, and a memory, and the implementation method is well-known to those skilled in the art, so a detailed description thereof is omitted.

As described above, the sensing module 800 according to one embodiment of the present disclosure can accurately detect replacement of the filter 20 or the flow path module 200 by detecting the magnetism of the magnetic 830 moved by the filter 20 or the flow path module 200 when the filter 20 is mounted on the filter frame 120 or the flow path module 200 is mounted on the main frame 110.

In addition, the sensing module 800 is configured as a single module, independent of the filter 20 or the flow path module 200, which includes the magnetic 830 and the reed switch 850 that detects the magnetism of the magnetic 830, thereby preventing the magnetic 830 from being discarded together with the filter 20 or the flow path module 200 when the filter 20 or the flow path module 200 is replaced. In this case, during the production of the filter 20 or the flow path module 200, there is no need to produce the magnetic 830 together with the filter 20 or the flow path module 200, so that the production cost can be reduced.

In addition, since the sensing module 800 can be selectively placed in the first posture and the second posture, it is possible to detect the replacement of a component that is mounted by moving vertically as well as a component that is mounted by moving horizontally, depending on the orientation of the movable member 820. In other words, when the sensing module 800 is oriented such that the movable member 820 moves horizontally, that is, when it is placed in the first posture, the movable member 820 moves horizontally to detect whether the filter 20 mounted in the filter frame 120 has been replaced. In addition, when the sensing module 800 is oriented such that the movable member 820 moves vertically, that is, when it is placed in the second posture, the movable member 820 moves vertically to detect whether the flow path module 200 mounted in the main frame 110 has been replaced.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

1. A sensing module comprising:
a support;
a movable member supported on the support to be movable relative to the support;
a magnetic supported on the movable member to be movable together with the movable member; and
a reed switch supported on the support,
wherein the reed switch detects the magnetic when the movable member moves to one side and the magnetic is positioned within a preset distance from the reed switch.

2. The sensing module of claim 1, further comprising:
an elastic member providing a restoring force to the movable member toward the other side opposite to the one side when the movable member moves to the one side,
wherein the elastic member has one end supported on the support and the other end supported on the movable member.

3. The sensing module of claim 1, wherein the movable member includes an engagement part extending in a direction opposite to a direction in which the movable member moves, and
wherein the support has a fixture formed therein that selectively interferes with the engagement part.

4. The sensing module of claim 3, wherein the fixture has a groove shape extending in the direction in which the movable member moves, and
wherein the engagement part is positioned inside the fixture, and when the movable member moves a predetermined distance to the one side, the movable member interferes with the fixture.

5. A water purifier comprising:
a frame including a filter frame in which a filter for filtering water is installed; and
a sensing module for detecting whether the filter has been replaced from the filter frame,
wherein the sensing module includes:
a support supported on the frame;
a movable member supported on the support to be movable relative to the support, the movable member moving in a direction away from the filter frame when the filter is installed in the filter frame;
a magnetic supported on the movable member to be movable together with the movable member; and
a reed switch supported on the support, and
wherein the reed switch detects the magnetic when the movable member moves in the direction away from the filter frame and the magnetic is positioned within a preset distance from the reed switch.

6. The water purifier of claim 5, further comprising:
an elastic member providing a restoring force to the movable member in a direction toward the filter frame when the movable member moves in the direction away from the filter frame,
wherein the elastic member has one end supported on the support and the other end supported on the movable member.

7. The water purifier of claim 5, wherein a through hole is formed in the filter frame, and
wherein at least a portion of the movable member passes through the through hole to be positioned inside the filter frame when the filter is removed from the filter frame.

8. The water purifier of claim 7, wherein the movable member includes:
a body part; and
an engagement part extending from the body part in a direction different from the direction in which the movable member moves, and
wherein the sensing module is supported on the frame to be placed in either a first posture in which at least a portion of the body part passes through the through hole to be positioned inside the filter frame or a second posture in which at least a portion of the engagement part passes through the through hole to be positioned inside the filter frame, when the filter is removed from the filter frame.

9. The water purifier of claim 5, further comprising:
a control device which determines that the filter has been replaced from the filter frame when the magnetic is detected by the reed switch.

10. A water purifier assembly comprising:
a filter for filtering water to provide purified water; and
a water purifier in which the filter is detachably mounted,
wherein the water purifier includes:
a frame including a filter frame in which the filter is installed; and
a sensing module for detecting whether the filter has been replaced from the filter frame,
wherein the sensing module includes:
a support supported on the frame;
a movable member supported on the support to be movable relative to the support, the movable member moving in a direction away from the filter frame when the filter is mounted in the filter frame;
a magnetic supported on the movable member to be movable together with the movable member; and
a reed switch supported on the support, and
wherein the reed switch detects the magnetic when the movable member moves in the direction away from the filter frame and the magnetic is positioned within a preset distance from the reed switch.
